(19) United States
(12) Patent Application Publication
(10) Pub. No.: US 2016/0180339 A1
(43) Pub. Date: Jun. 23, 2016

(54) METHOD AND SYSTEM FOR INDUSTRY-BASED SUPPRESSION OF PAYMENT TRANSACTIONS

(71) Applicant: MasterCard International Incorporated, Purchase, NY (US)

(72) Inventors: Michael ZHAO, New York, NY (US); Jeremy Pastore, Brooklyn, NY (US); Arun Elangovan, Astoria, NY (US)

(73) Assignee: MASTERCARD INTERNATIONAL INCORPORATED, Purchase, NY (US)

(21) Appl. No.: 14/575,058

(22) Filed: Dec. 18, 2014

(51) Int. Cl. G06Q 20/40

(52) U.S. Cl. CPC G06Q 20/40

(57) ABSTRACT

A method for suppressing payment transactions based on industry classification includes: storing an account profile, the profile including data related to one or more transaction accounts including a plurality of industry thresholds, each industry threshold being associated with a merchant industry; receiving an authorization request for a payment transaction, the request including a transaction amount and a merchant identifier associated with a merchant involved in the payment transaction; identifying a specific merchant industry associated with the merchant involved in the payment transaction based on the merchant identifier; processing the payment transaction if the transaction amount does not exceed an industry threshold associated with the specific merchant industry; and transmitting an authorization response declining the payment transaction if the transaction amount exceeds the industry threshold associated with the specific merchant industry.

### FIELD

The present disclosure relates to the suppression of payment transaction based on industry thresholds, specifically the setting of thresholds for a plurality of industries by a consumer for suppression of payment transactions based thereon for monitoring and management by the consumer.

### BACKGROUND

Budgeting can be an important activity for many consumers in order to manage their cash flow and spending. For some consumers, setting a budget for themselves and following it can be a simple task. However, for many others, it may be difficult to stay within the parameters of their budget due to any number of factors, such as impulse spending, lack of awareness or self-control, etc. As a result, a number of budgeting tools have been developed to help create a budget for a consumer, track the consumer's transactions, and alert the consumer if their transactions are approaching a certain level in their budget. Examples of such methods can be found in U.S. patent application Ser. No. 14/481,198, filed Sep. 9, 2014; U.S. Pat. No. 8,706,575, issued Apr. 22, 2014; and U.S. application Ser. No. 14/481,289, filed Sep. 9, 2014, which are herein incorporated by reference in their entirety. But these programs tend to report after the fact of a purchase or other transaction.

While these budgeting tools can often assist consumers with setting a budget and monitoring their spending, some consumers may still find themselves lacking awareness and possibly exceeding their budget and spending more than they should. As a result, some methods have been developed that can place a hard limit on a consumer's spending. For instance, the inControl™ platform by MasterCard® enables consumers to set limits for a payment card or controlled payment number. A consumer can, for example, set a monthly transaction limit for a payment card for $500, where any transactions that would result in exceeding the limit would be denied. Additional detail regarding controlled payment numbers and placing controls on consumer spending can be found in U.S. Pat. No. 6,636,833, issued Oct. 21, 2003; U.S. Pat. No. 7,136,835, issued Nov. 14, 2006; U.S. Pat. No. 7,571,142, issued Aug. 4, 2009; U.S. Pat. No. 7,567,934, issued Jul. 28, 2009; U.S. Pat. No. 7,593,896, issued Sep. 22, 2009; U.S. Pat. No. 8,756,150, issued Jun. 17, 2014; U.S. Pat. No. 8,639,623, issued Jan. 28, 2014; U.S. Pat. No. 8,527,416, issued Sep. 3, 2013; U.S. Pat. No. 8,510,218, issued Aug. 13, 2013; U.S. Patent Application No. 2007/0276736, published Nov. 29, 2007; U.S. patent application Ser. No. 12/219,952, filed Jul. 30, 2008; U.S. patent application Ser. No. 12/268,063, filed Nov. 10, 2008; and U.S. patent application Ser. No. 12/359,971, filed Jan. 26, 2009; each of which are herein incorporated by reference in their entirety.

However, while platforms such as inControl™ provide a consumer with tools to place limits on their spending behavior, such platforms may not be ideally effective for all consumers. For instance, some consumers may need additional guidance in terms of what types of controls should be used, what kinds of limits should be set on the controls, and how transactions and the limits themselves should be handled once a threshold has been reached. Thus, there is a need for a technical system that enables a consumer to set spending thresholds for a plurality of merchant industries where payment transactions in an industry are suppressed if the threshold for that industry is reached.

### SUMMARY

The present disclosure provides a description of systems and methods for suppressing payment transactions based on industry classification.

A method for suppressing payment transactions based on industry classification includes: storing, in an account database, an account profile, wherein the account profile includes data related to one or more transaction accounts including at least a plurality of industry thresholds, each industry threshold being associated with a merchant industry; receiving, by a receiving device, an authorization request for a payment transaction, wherein the authorization request includes at least a transaction amount and a merchant identifier associated with a merchant involved in the payment transaction; identifying, by a processing device, a specific merchant industry associated with the merchant involved in the payment transaction based on at least the merchant identifier; processing, by the processing device, the payment transaction if the transaction amount does not exceed an industry threshold or the plurality of industry thresholds associated with the specific merchant industry; and transmitting, by a transmitting device, an authorization response declining the payment transaction if the transaction amount exceeds the industry threshold of the plurality of industry thresholds associated with the specific merchant industry.

A system for suppressing payment transactions based on industry classification includes an account database, a receiving device, a processing device, and a transmitting device. The account database is configured to store an account profile, wherein the account profile includes data related to one or more transaction accounts including at least a plurality of industry thresholds, each industry threshold being associated with a merchant industry. The receiving device is configured to receive an authorization request for a payment transaction, wherein the authorization request includes at least a transaction amount and a merchant identifier associated with a merchant involved in the payment transaction. The processing device is configured to: identify a specific merchant industry associated with the merchant involved in the payment transaction based on at least the merchant identifier; and process the payment transaction if the transaction amount does not exceed an industry threshold of the plurality or industry thresholds associated with the specific merchant industry. The transmitting device is configured to transmit an authorization response declining the payment transaction if the transaction amount exceeds the industry threshold of the plurality of industry thresholds associated with the specific merchant industry.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for suppressing payment transactions based on industry classification in accordance with exemplary embodiments.

FIG. 2 is a block diagram illustrating the processing server 102 of FIG. 1 for the suppressing payment transactions based on industry classification in accordance with exemplary embodiments.

FIG. 3 is a block diagram illustrating the account database of the processing server of FIG. 2 for storing industry threshold data for use in suppressing payment transactions in accordance with exemplary embodiments.

FIG. 4 is a flow diagram illustrating a process for suppressing payment transactions based on industry classification in accordance with exemplary embodiments.

FIG. 5 is a diagram illustrating a graphical user interface for setting industry thresholds for transaction suppression in accordance with exemplary embodiments.

FIG. 6 is a flow chart illustrating an exemplary method for suppressing payment transactions based on industry classification in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc. In some instances, a transaction account may refer to multiple accounts, such as multiple transaction accounts associated with a single consumer across one or multiple issuers, multiple transaction accounts in a single consumer wallet, or an otherwise associated group of transaction accounts.

### System for Industry-Based Suppression of Transactions

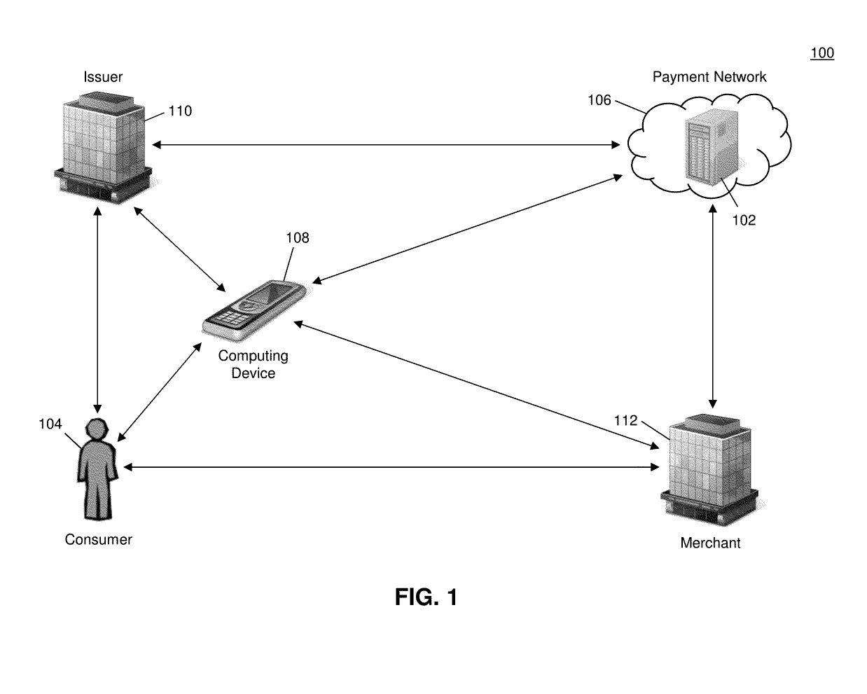

FIG. 1 illustrates a system 100 for the suppression of payment transactions based on industry classification.

The system 100 may include a processing server 102. The processing server 102, discussed in more detail below, may be configured to suppress payment transactions for a consumer 104 based on industry classification for the payment transactions and industry thresholds provided by the consumer 104. The processing server 102 may be part of a payment network 106 that is configured to process payment transactions. As part of the processing of the payment transactions, and industry classification for each transaction may be identified, and consumer spending for that classification also identified. If the consumer spending for the classification exceeds a previously established industry threshold for that classification, then the processing server 102 may cause the payment network 106 to suppress (e.g., decline, recommend denial of, etc.) the payment transaction.

In order to set thresholds for industry classifications, the consumer 104 may communicate with the processing server 102 using any suitable method, such as via a computing device 108. The computing device 108 may be any type of computing device suitable for performing the functions disclosed herein, such as a mobile communication device, cellular phone, smart phone, tablet computer, laptop computer, notebook computer, desktop computer, smart television, smart watch, telephone, etc. The consumer 104 may use the computing device 108 to communicate with the processing server 102 and set thresholds for a plurality of industry classifications.

In some embodiments, the processing server 102 may provide the industry classifications. Industry classifications may be according to Merchant Category Codes (MCCs), and are not limited thereto. They may include accommodations and food services, administrative support, waste management and remediation services, agriculture, apparel and accessories, arts and entertainment, recreation, communications, construction services, consumer electronics and computers, education services, finance and insurance, general merchandise, grocery and food stores, health and personal care, health care and social assistance, home improvement, information, manufacturing, motor vehicles, professional services, scientific and technical services, public administration, real estate, sporting goods and hobbies, transportation and warehousing, utilities, wholesale trade, and other services. In some instances, a classification may include multiple subclasses, such as the apparel and accessories classification including women's apparel, men's apparel, children's apparel, family apparel, jewelry and giftware, luggage and leather, shoes, and miscellaneous apparel subclasses. In such instances, the consumer 104 may be able to set a threshold for the larger, “super” industry classification and/or for the subclasses of the super industry classification. For instance, the consumer 104 may set a threshold for each of the subclasses of apparel and accessories, as well as an overall threshold for the apparel and accessories classification.

By providing the consumer 104 with the plurality of classifications to set a threshold for, the consumer 104 may be able to set thresholds on their spending without having to identify and create merchant groups themselves. In addition, the setting and management of industry classifications by the payment network 106 may ensure that payment transactions that are conducted can be easily matched to a classification, which may otherwise be difficult for consumer-set merchant groups. As a result, the methods and systems discussed herein may provide for more efficient setting of industry thresholds and identification of payment transactions based thereof.

In some embodiments, the consumer 104 may set industry thresholds using discrete amounts. In other embodiments, the consumer 104 may use percentages, such as a percentage of total spending, of average spending for the consumer 104, of average spending for all consumers, of average spending for related consumers (e.g., related via overall spending, demographics, microsegment, etc.). In some instances, the consumer 104 may use a combination of discrete amounts and percentages.

In some embodiments, the processing server 102 may provide predetermined thresholds, such as based on the consumer's 104 average spending, average spending for other consumers, thresholds set by other consumers, thresholds set by related consumers, etc. For instance, the processing server 102 may provide a recommended threshold for each industry classification to the consumer 104 based on the consumer's 104 average spending in each industry classification. In some instances, recommendations may also be made based on consumer preferences. For example, the consumer 104 may indicate a desire to reduce spending in an industry or may indicate an interest in having a high threshold in an industry. The thresholds recommended by the processing server 102 or made available for selection by the consumer 104 may be based thereon.

Once the industry thresholds have been set by the consumer 104, the processing server 102 may save the thresholds in an account profile associated with the consumer 102, discussed in more detail below. In some instances, industry thresholds may be associated with a single transaction account associated with the consumer 104. For instance, the consumer 104 may have a transaction account issued by an issuer 110, which may be an issuing financial institution, such as an issuing bank. The industry thresholds may be associated with the transaction account held by the issuer 110 such that when the consumer 104 conducts a payment transaction using the transaction account with a merchant 112, the processing server 102 may evaluate the transaction to determine if an associate threshold is exceeded before forwarding an authorization request for the transaction to the issuer 110.

In instances where the threshold is exceeded by a payment transaction, the processing server 102 may suppress the transaction in any of a number of ways. For instance, the processing server 102 may deny the payment transaction and provide an authorization response indicated thereby to the merchant 112 (e.g., or to an acquirer associated with the merchant 112). In some embodiments, the processing server 102 may forward the authorization request to the issuer 110 with a recommendation that the transaction be denied due to the exceeding of the threshold. In some cases, the denial of the transaction or recommendation of denial thereof may be based on the transaction account, the issuer 110, the consumer 104, the industry classification, the threshold, the amount by which the threshold may be exceeded, etc. the consumer 104 may be given the option to exceed the threshold or reset the reset the threshold via a separate communication path to his or her computing device 108, as explained below. In instances where the threshold is not exceeded by the transaction, the payment network 106 may process the transaction using traditional processes.

In some embodiments, industry thresholds may be associated with a plurality of transaction accounts. For instance, the consumer 104 may have a plurality of transaction accounts with the issuer 110, and may set a threshold for spending that applies to each of the plurality of transaction accounts. In another instance, the consumer 104 may set a threshold for payment transactions for all transaction accounts associated with the consumer 104, which may be held across multiple issuers 110 and financial institutions. In yet another instance, industry thresholds may apply to a group of transaction accounts, such as all transaction accounts included in an electronic wallet, such as a wallet application included in the computing device 108. Other types of transaction account groups will be apparent to persons having skill in the relevant art. In some instances, the consumer 104 may set a threshold for an industry for each of a plurality of transaction accounts, as well as an overall threshold for that industry applicable to all of the transaction accounts.

In some embodiments, the consumer 104 may set industry thresholds for a different consumer. For example, a parent may set thresholds for spending in industry classifications for their child. In another example, an employer may set industry thresholds for their employees. In such instances, the thresholds may be applicable to payment transactions involving the specific party to which the threshold applies, which may be identified based on the transaction account used to fund the payment transaction or other method of identification, such as the specific payment card used for a transaction account for which multiple payment cards are issued.

In some instances, the processing server 102 may provide the consumer 104 with an opportunity to override suppression of a payment transaction when a threshold is exceeded. For example, if the processing server 102 identifies that an industry threshold is exceeded by a payment transaction, the processing server 102 may transmit a message to the consumer 104 indicating thereof, such as via a text message, notification, e-mail, telephone call, or other suitable method to the computing device 108. The consumer 104 may receive the message and may provide authorization to the processing server 102 to not suppress the payment transaction. In some instances, the authorization may include authentication information for use by the processing server 102 in authenticating that the message is coming from a person (e.g., the consumer 104) authorized to withhold suppression of a payment transaction. If the transaction is not suppressed, the processing of the transaction may proceed using traditional methods and systems.

In some embodiments, once a threshold has been reached for an industry classification, the processing server 102 may transmit a notification to the consumer 104, such as via the computing device 108. For example, the notification may be sent via short message service message, multimedia message service message, e-mail, a webpage, a telephone call, an application program executed by the computing device 108, or other suitable method. The notification may indicate that the respective industry classification has been exceeded.

In some embodiments, the consumer 104 may request to reset the threshold for an industry classification once it has been exceeded. In such an embodiment, once the consumer 104 receives the notification that the industry has been exceeded, the consumer 104 may request that the threshold is reset, after which the processing server 102 may reset the threshold for that industry classification and proceed with processing payment transactions as usual. In some instances, the processing server 102 may delay the resetting of the industry threshold for a predetermined period of time. For example, the processing server 102 may wait twenty-four hours before resetting an industry threshold. This may prevent a consumer 104 from making an impulse buy above their threshold, by causing them to wait a twenty-four hour period before conducting the transaction. The predetermined period of time may be set by the consumer 104, the processing server 102, the issuer 110, or other suitable entity, and may be a set period of time for all thresholds, may be specific to each individual classification, may be based on the threshold amount, etc. In some instances, industry thresholds may be reset at predetermined periods of time, such as at a predetermined interval (e.g., weekly, monthly, quarterly, annually, etc.). In such an instance, the predetermined period of time may be set by the consumer 104, the processing server 102, issuer 110, or other suitable entity.

In some embodiments, changes to industry thresholds set by the consumer 104 may take effect in a similar fashion to the resetting of an industry threshold. For example, if the consumer 104 wants to increase a threshold for an industry classification, the increase may not take effect until after a predetermined delay or at a specified period of time (e.g., at the next reset time). In some instances, an increase to a threshold may have a delayed effectiveness, while a decreased threshold may become effective immediately.

By providing the consumer 104 with the industry classifications and tools for assistance in the identification of thresholds for each classification, the processing server 102 may provide for systems for suppressing payment transactions based on classification that are more simpler and more efficient for consumers 104. In addition, by controlling the resetting of thresholds, such as via delays and waiting periods, consumers that may traditionally have difficulty following budgets and spending limits may be prevented from making impulsive purchases and may be encouraged to spend more time considering purchases in instances where they may not have otherwise. As a result, the methods and systems discussed herein may result in improved budgeting and spending by consumers 104 via easier and more efficient processes via the suppression of payment transactions based on industry classification.

### Processing Server

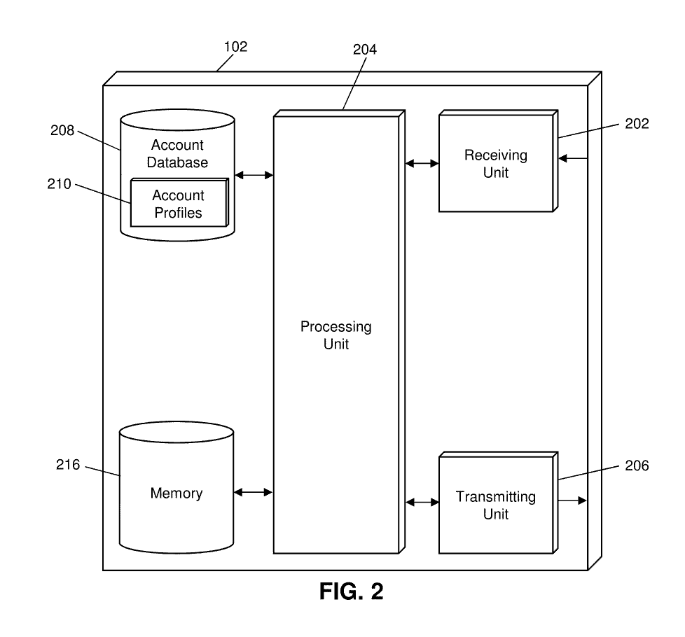

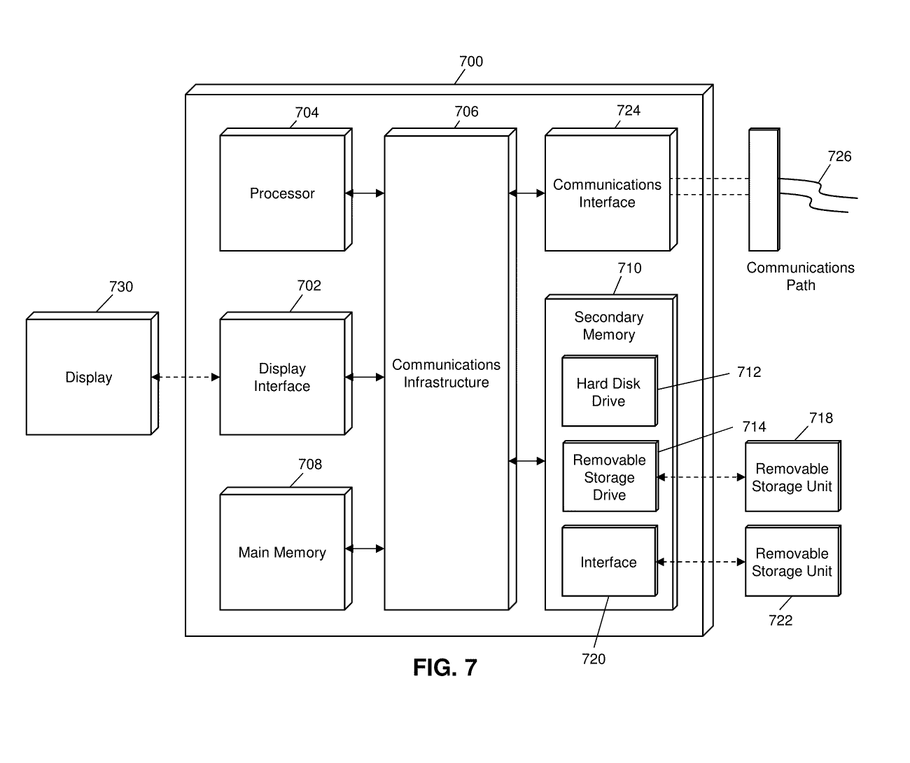

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 700 illustrated in FIG. 7 and discussed in more detail below may be a suitable configuration of the processing server 102.

The processing server 102 may include a receiving unit 202. The receiving unit 202 may be configured to receive data over one or more networks via one or more network protocols. The receiving unit 202 may receive a plurality of industry thresholds from the consumer 104, such as via the computing device 108. In some instances, the industry thresholds may be received by a different computing device (e.g., by a user entering industry thresholds on behalf of consumers 104) or may be directly entered into the processing server 102, such as via an input device configured to communicate with the receiving unit 202. The received industry thresholds may be stored in an account database 208, discussed in more detail below, in an account profile 210 associated with one or more transaction accounts.

The receiving unit 202 may also receive authorization requests for payment transactions. Each authorization request may include at least an account identifier, a merchant identifier, and a transaction amount. The processing server 102 may include a processing unit 204. The processing unit 204 may be configured to perform the functions of the processing server 102 discussed herein as will be apparent to persons having skill in the relevant art. The processing server 102 may be configured to identify an industry classification for a payment transaction based on the merchant involved in the payment transaction using the merchant identifier. In some instances, the merchant identifier may be the industry classification. In other instances, the processing unit 204 may identify an industry classification associated with the merchant identifier, such as via a lookup table.

The processing unit 204 may also be configured to identify an account profile 210 associated with the payment transaction. The account profile 210 may be identified via an account identifier, discussed in more detail below, included in the received authorization request and the associated account profile 210. Once the account profile 210 and the industry classification of the merchant 112 involved in the transaction have been identified, the processing unit 204 may determine if a threshold for the industry classification has been exceeded based on current spending in the classification and the transaction amount for the payment transaction. If the threshold has not been exceeded, then the processing unit 204 may process the payment transaction using traditional methods and systems, and may update the account profile 210 to reflect the additional spending for the payment transaction based on the transaction amount.

If the threshold has been exceeded, then the processing unit 204 may generate a notification to be transmitted to the consumer 104. The notification may notify the consumer 104 that the threshold for the industry classification of the merchant 112 involved in the payment transaction has been exceeded. In some embodiments, the notification may also include an indication that the consumer 104 may still authorize processing of the payment transaction. The processing server 102 may include a transmitting unit 206 configured to transmit data over one or more networks via one or more network protocols, which may transmit the generated notification to the consumer 104 using methods and systems that will be apparent to persons having skill in the relevant art. In embodiments where the consumer 104 may be able to authorize the processing of a payment transaction exceeding a threshold, the receiving unit 202 may be further configured to receive a message from the consumer 104 indicating that the transaction be processed. The processing unit 204 may then proceed with processing the payment transaction using traditional systems and methods.

The receiving unit 202 may also be configured to receive requests to update and/or reset industry thresholds. The processing unit 204 may identify an account profile 210 associated with the request, such as based on an account identifier included in the received request, and may initiate resetting or updating of the indicated industry threshold(s). In some embodiments, the processing unit 204 may delay resetting or updating an industry threshold. In such an embodiment, the processing unit 204 may wait a predetermined period of time or may wait until a predetermined period of time to reset or update the threshold. The predetermined period of time may be included in the account profile 210 that is being managed or may be stored in a memory 216.

The memory 216 may be configured to store data for the processing server 102 suitable for performing the functions of the processing server 102 discussed herein. For example, the memory 216 may store timing information for updating and/or resetting industry thresholds, lookup tables for industry classifications, rules and algorithms for the identification and recommendation of industry thresholds, etc. Additional data that may be included in the memory 216 will be apparent to persons having skill in the relevant art.

In some embodiments, the processing unit 204 may be further configured to calculate recommended industry thresholds or industry threshold ranges, such as by using algorithms stored in the memory 216. The calculations may be based on transaction data for payment transactions involving a consumer 104 which may be stored in the associated account profile 210. The processing unit 204 may identify industry classifications for each payment transaction and may identify average consumer spending and recommended spending amounts using methods and systems that will be apparent to persons having skill in the relevant art.

It will also be apparent to persons having skill in the relevant art that the processing server 102 may include additional components and that the components illustrated in FIG. 2 and discussed herein may be configured to perform additional functions. For instance, the receiving unit 202, processing unit 204, and transmitting unit 206 may be configured to perform traditional functions for the processing of payment transactions, such as the transmitting of authorization requests, receiving of authorization responses, etc.

### Account Database

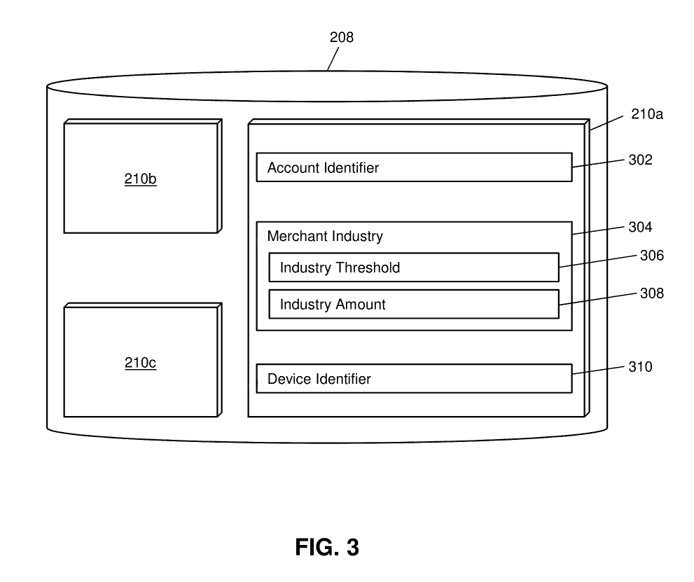

FIG. 3 illustrates the account database 208 of the processing server 102. The account database 208 may be configured to store a plurality of account profiles 210, illustrated as account profiles 210a, 210b, and 210c. Each account profile 210 may be related to one or more transaction accounts and may include at least an account identifier 302 and a plurality of merchant industries 304. The account identifier may be a unique value associated with the related one or more transaction accounts or a consumer related thereof, such as an account number, identification number, consumer identification number, phone number, email address, username, etc. In some instances, an account profile 210 may include an account identifier 302 for each related transaction account.

For each merchant industry 304, the account profile 210 may include at least an industry threshold 306 and an industry amount 308 associated with the respective merchant industry 304. The industry threshold 306 may be a threshold or limit for the respective merchant industry 304 such that any payment transactions attempted that exceed the industry threshold 306 will be suppressed by the processing server 102. The industry threshold 306 may be a discrete value (e.g., $300), a percentage (e.g., 20% of spending), or other suitable value. The industry amount 308 may be an amount of spending in the respective merchant industry 304. The industry amount 308 may be used by the processing unit 204 to determine if the industry threshold 306 has been exceeded, and may be updated any time a payment transaction associated with the respective merchant industry 304 has been processed.

The account profile 210 may also include a device identifier 310. The device identifier may be a unique value associated with a computing device 108 associated with the related transaction account. The device identifier may be an identification number, registration number, serial number, media access control address, internet protocol address, username, email address, phone number, or other suitable value that will be apparent to persons having skill in the relevant art. The device identifier 310 may be used by the transmitting unit 206 for the transmitting of notifications and messages to the associated computing device 108, such as notifications that an industry threshold has been exceeded.

In some embodiments, each account profile 210 may further include transaction data. The transaction data may include data related to a plurality of payment transactions involving the related transaction account. The transaction data may include transaction amounts, industry classifications, and other data that will be apparent to persons having skill in the relevant art. The transaction data may be used by the processing unit 204 to determine industry amounts 308, recommend industry thresholds 306, etc.

### Process for Suppressing Payment Transactions

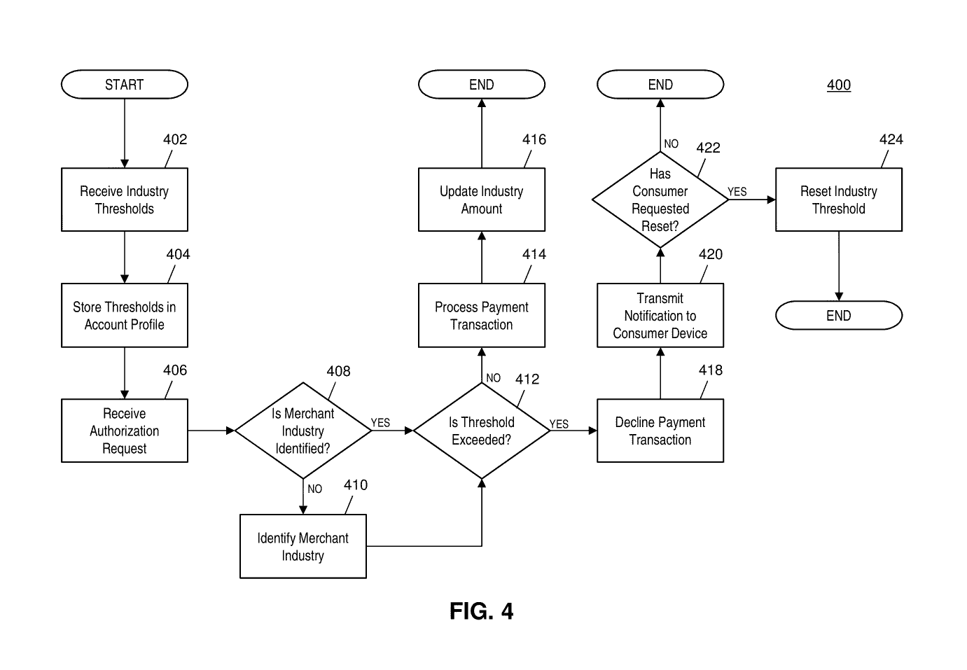

FIG. 4 illustrates a process 400 for the suppression of payment transactions based on industry classification and thresholds set thereof.

In step 402, the receiving unit 202 may receive industry threshold amounts from the consumer 104 for a plurality of merchant industries. In step 404, the processing unit 204 may store the threshold amounts as industry thresholds 306 associated with the respective merchant industries 304 in an account profile 210 associated with the consumer 104. In step 406, the receiving unit 202 may receive an authorization request for a payment transaction involving the consumer 104. The authorization request may include at least a transaction amount and a merchant identifier.

In step 408, the processing unit 204 may determine if a merchant industry is identified in the authorization request. The merchant industry may be the merchant identifier, or may be included in a separate data field in the authorization request. If the merchant industry classification is not identified in the authorization request, then, in step 410, the processing unit 204 may identify the industry classification associated with the merchant 112 involved in the payment transaction. Identification of the industry classification may include looking up the industry classification associated with the merchant identifier in a lookup table, which may be stored in the memory 216 of the processing server 102.

Once the industry classification of the merchant 112 has been identified, then, in step 412, the processing unit 204 may determine if the industry threshold 306 for that classification has been exceeded or will be exceeded by the payment transaction. The determination may be based on the industry amount 308 for the classification and the transaction amount for the payment transaction as included in the received authorization request. If the industry threshold 306 has not been exceeded, then, in step 414, the processing unit 204 may process the payment transaction using traditional processes. In step 416, the processing unit 204 may update the industry amount 308 for the classification based on the transaction amount included in the authorization request and the processing of the payment transaction (e.g., if the payment transaction was approved and processing successful).

If the industry threshold 306 is exceeded, then, in step 418, the processing unit 204 may decline the payment transaction. The declining of the payment transaction may include generating, by the processing unit 204, an authorization response indicating denial of the payment transaction and transmission, by the transmitting unit 206, thereof to the merchant 112. In step 420, the transmitting unit 206 may transmit a notification to the computing device 108 associated with the consumer 104 (e.g., based on the device identifier 310 included in the account profile 210) to the consumer 104 indicating that the industry threshold 306 has been exceeded.

In step 422, the processing unit 204 may determine if the consumer 104 has requested a reset of the industry threshold 306. The determination may be based on if the receiving unit 202 has received a request from the consumer 104 (e.g., via the computing device 108) that the industry threshold 306 be reset. If no request has been received, then the process 400 may be completed. If a request is received, then, in step 424, the processing unit 204 may reset the industry threshold 306 by resetting the industry amount 308 for the classification to zero. In some embodiments, the processing unit 204 may wait a predetermined period of time to reset the industry threshold 306, which may be stored in the account profile 210 or the memory 216.

### Graphical User Interface

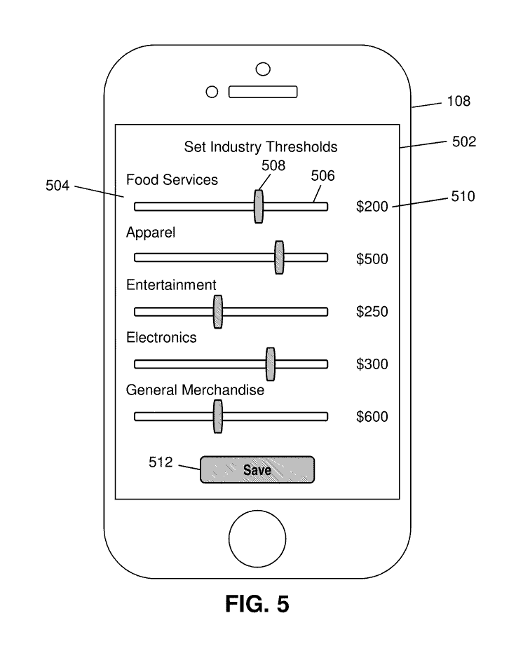

FIG. 5 illustrates a graphical user interface of the computing device 108 for the selection of industry thresholds 306 by the consumer 104. It will be apparent to persons having skill in the relevant art that the graphical user interface illustrated in FIG. 5 and discussed herein is provided as an example illustration only, and that additional and/or alternative graphical user interfaces including additional and/or alternative components may be used in performing the methods and systems discussed herein.

The computing device 108 may include a display 502. The display 502 may be any suitable type of display device, such as a light-emitting diode display, liquid crystal display, capacitive touch screen display, etc. In the example illustrated in FIG. 5, the display 502 is a touch screen display that can also serve as an input device to receive input from the consumer 104.

The display 502 may display a plurality of industry classifications 504. Each industry classification 504 may be associated with a merchant industry 304 in the consumer's 104 account profile 210. In some embodiments, each industry classification 504 may include a plurality of subclasses for which the consumer 104 may set an industry threshold 306. In such an embodiment, the industry classification 504 may or may not have a separate industry threshold 306 set thereof.

In the example illustrated in FIG. 5, each industry classification 504 may include a threshold range 506 and a threshold selector 508. The threshold selector 508 may be moved along the threshold range 506 by the consumer 104 to select a desired threshold value 510. The threshold value 510 may be based on the position of the threshold selector 508 on the threshold range 506, such as where moving the threshold selector 508 to the right may increase the threshold value 510 to a higher value. In some instances, the threshold value 510 may be based purely on the position of the threshold selector 508 for a range of values (e.g., from $0 to $1,000). In other instances, the threshold value 510 may be based on the position of the threshold selector 508 and a budget for the consumer 104 (e.g., a percentage of the budget from 0 to 100%). The budget may be set by the consumer 104, based on the consumer's 104 spending history, based on other consumer thresholds and budgets, and may be based on the spending regarding the specific industry classification 504 or overall spending.

The consumer 104 may set the threshold selector 508 to a spot corresponding to a desired threshold value 510 for each of the industry classifications 504. Once the consumer 104 is satisfied with the threshold values 510, the consumer 104 may press a save button 512. The save button 512 may initiate the transmitting of the selected threshold values 510 to the processing server 102. The receiving unit 202 of the processing server 102 may receive the threshold values 510 for use in updating the industry thresholds 306 of the account profile 210 associated with the consumer 104.

### Exemplary Method for Suppressing Payment Transactions Based on Industry Classification

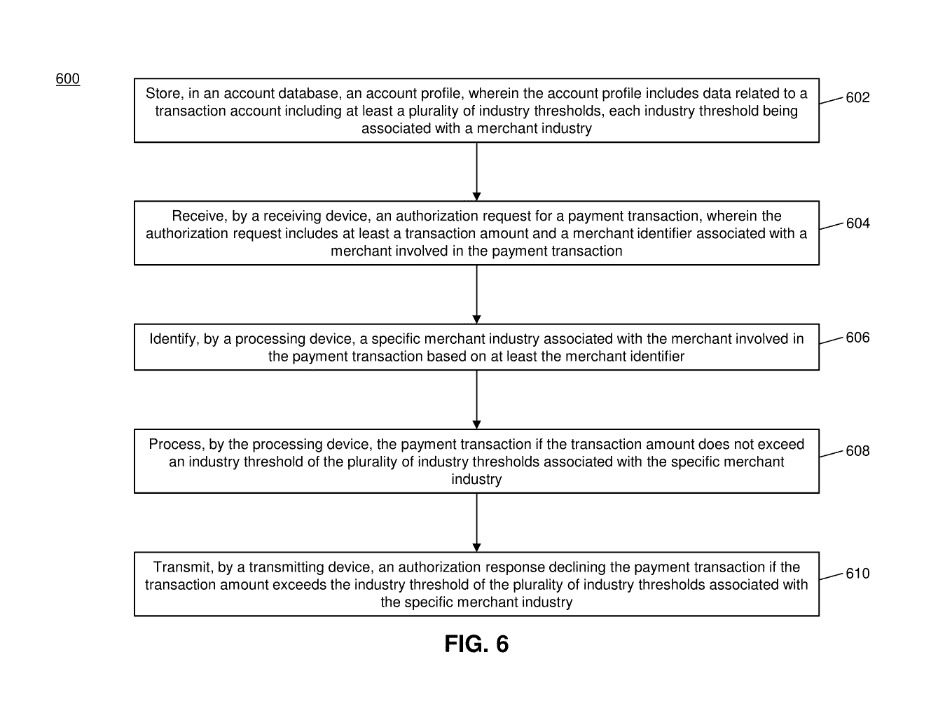

FIG. 6 illustrates a method 600 for suppressing payment transactions based on industry classification.

In step 602, an account profile (e.g., account profile 210) may be stored in an account database (e.g., the account database 208), wherein the account profile 210 includes data related to one or more transaction accounts including at least a plurality of industry thresholds (e.g., industry thresholds 306), each industry threshold 306 being associated with a merchant industry (e.g., merchant industry 304). In step 604, an authorization request for a payment transaction may be received by a receiving device (e.g., the receiving unit 202), wherein the authorization request includes at least a transaction amount and a merchant identifier associated with a merchant (e.g., the merchant 112) involved in the payment transaction.

In step 606, a specific merchant industry associated with the merchant 112 involved in the payment transaction may be identified by a processing device (e.g., the processing unit 204) based on at least the merchant identifier. In one embodiment, the authorization request may include the specific merchant industry. In another embodiment, identifying the specific merchant industry may include identifying an entry associated with the merchant identifier in a lookup table that includes the specific merchant industry.

In step 608, the payment transaction may be processed by the processing device 204 if the transaction amount does not exceed an industry threshold 306 of the plurality of industry thresholds associated with the specific merchant industry. In step 610, an authorization response declining the payment transaction may be transmitted by a transmitting device (e.g., the transmitting unit 206) if the transaction amount exceeds the industry threshold 306 of the plurality of industry thresholds associated with the specific merchant industry.

In some embodiments, the account profile 210 may further include a plurality of industry amounts (e.g., industry amounts 308), wherein each industry amount 308 corresponds to an industry threshold 306 of the plurality of industry thresholds, and the processing and transmitting steps are preformed if the transaction amount added to the industry amount 308 corresponding to the industry threshold 306 associated with the specific merchant industry does not or does exceed the industry threshold 306 associated with the specific merchant industry, respectively. In a further embodiment, processing the payment transaction may further include updating, in the account profile 210, the industry amount 308 corresponding to the industry threshold 306 associated with the specific merchant industry based on the transaction amount.

In one embodiment, the method 600 may further include transmitting, by the transmitting device 206, a notification to a computing device (e.g., the computing device 108) associated with at least one of the one or more transaction accounts, wherein the notification indicates that the payment transaction exceeds the industry threshold 306 associated with the specific merchant industry if the transaction amount exceeds the industry threshold 306 associated with the specific merchant industry. In a further embodiment, the notification may be transmitted to the computing device 108 before transmitting the authorization response.

In an even further embodiment, the method 600 may also include: receiving, by the receiving device 202, a notification from the computing device 108 indicating approval of the payment transaction by a consumer (e.g., the consumer 104) associated with at least one of the one or more transaction accounts; and processing, by the processing device 202, the payment transaction. In another even further embodiment, the authorization response may not be transmitted due to the processing of the payment transaction.

In some embodiments where the notification may be transmitted to the computing device 108, the method 600 may even further include: receiving, by the receiving device 202, a request from the computing device 108 requesting resetting of the industry threshold 306 associated with the specific merchant industry; and resetting, in the account profile 210, the industry threshold 306 associated with the specific merchant industry.

### Computer System Architecture

FIG. 7 illustrates a computer system 700 in which embodiments of the present disclosure, or portions thereof, may be implemented as computer-readable code. For example, the processing server 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 4 and 6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 4 and 6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for suppressing payment transactions based on industry classification. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for suppressing payment transactions based on industry classification, comprising:
storing, in an account database, an account profile, wherein the account profile includes data related to one or more transaction accounts including at least a plurality of industry thresholds, each industry threshold being associated with a merchant industry;
receiving, by a receiving device, an authorization request for a payment transaction, wherein the authorization request includes at least a transaction amount and a merchant identifier associated with a merchant involved in the payment transaction;
identifying, by a processing device, a specific merchant industry associated with the merchant involved in the payment transaction based on at least the merchant identifier;
processing, by the processing device, the payment transaction if the transaction amount does not exceed an industry threshold of the plurality of industry thresholds associated with the specific merchant industry; and
transmitting, by a transmitting device, an authorization response declining the payment transaction if the transaction amount exceeds the industry threshold of the plurality of industry thresholds associated with the specific merchant industry.

2. The method of claim 1, further comprising:
transmitting, by the transmitting device, a notification to a computing device associated with at least one of the one or more transaction accounts, wherein the notification indicates that the payment transaction exceeds the industry threshold associated with the specific merchant industry if the transaction amount exceeds the industry threshold associated with the specific merchant industry.

3. The method of claim 2, wherein the notification is transmitted to the computing device before transmitting the authorization response.

4. The method of claim 3, further comprising:
receiving, by the receiving device, a notification from the computing device indicating approval of the payment transaction by a consumer associated with at least one of the one or more transaction accounts; and
processing, by the processing device, the payment transaction.

5. The method of claim 4, wherein the authorization response is not transmitted.

6. The method of claim 2, further comprising:
receiving, by the receiving device, a request from the computing device requesting resetting of the industry threshold associated with the specific merchant industry; and
resetting, in the account profile, the industry threshold associated with the specific merchant industry.

7. The method of claim 1, wherein
the account profile further includes a plurality of industry amounts, wherein each industry amount corresponds to an industry threshold of the plurality of industry thresholds, and
the processing and transmitting steps are performed if the transaction amount added to the industry amount corresponding to the industry threshold associated with the specific merchant industry does not or does exceed the industry threshold associated with the specific merchant industry, respectively.

8. The method of claim 7, wherein processing the payment transaction further includes updating, in the account profile, the industry amount corresponding to the industry threshold associated with the specific merchant industry based on the transaction amount.

9. The method of claim 1, wherein the authorization request includes the specific merchant industry.

10. The method of claim 1, wherein identifying the specific merchant industry includes identifying an entry associated with the merchant identifier in a lookup table that includes the specific merchant industry.

11. A system for suppressing payment transactions based on industry classification, comprising:
an account database configured to store an account profile, wherein the account profile includes data related to one or more transaction accounts including at least a plurality of industry thresholds, each industry threshold being associated with a merchant industry;
a receiving device configured to receive an authorization request for a payment transaction, wherein the authorization request includes at least a transaction amount and a merchant identifier associated with a merchant involved in the payment transaction;
a processing device configured to
identify a specific merchant industry associated with the merchant involved in the payment transaction based on at least the merchant identifier, and
process the payment transaction if the transaction amount does not exceed an industry threshold of the plurality of industry thresholds associated with the specific merchant industry; and
a transmitting device configured to transmit an authorization response declining the payment transaction if the transaction amount exceeds the industry threshold of the plurality of industry thresholds associated with the specific merchant industry.

12. The system of claim 11, wherein the transmitting device is further configured to transmit a notification to a computing device associated with at least one of the one or more transaction accounts, wherein the notification indicates that the payment transaction exceeds the industry threshold associated with the specific merchant industry if the transaction amount exceeds the industry threshold associated with the specific merchant industry.

13. The system of claim 12, wherein the notification is transmitted to the computing device before transmitting the authorization response.

14. The system of claim 13, wherein
the receiving device is further configured to receive a notification from the computing device indicating approval of the payment transaction by a consumer associated with at least one of the one or more transaction accounts, and
the processing device is further configured to process the payment transaction.

15. The system of claim 14, wherein the authorization response is not transmitted.

16. The system of claim 12, wherein
the receiving device is further configured to receive a request from the computing device requesting resetting of the industry threshold associated with the specific merchant industry, and
the processing device is further configured to reset, in the account profile, the industry threshold associated with the specific merchant industry.

17. The system of claim 11, wherein
the account profile further includes a plurality of industry amounts, wherein each industry amount corresponds to an industry threshold of the plurality of industry thresholds, and
the processing and transmitting steps are performed if the transaction amount added to the industry amount corresponding to the industry threshold associated with the specific merchant industry does not or does exceed the industry threshold associated with the specific merchant industry, respectively.

18. The system of claim 17, wherein processing the payment transaction further includes updating, in the account profile, the industry amount corresponding to the industry threshold associated with the specific merchant industry based on the transaction amount.

19. The system of claim 11, wherein the authorization request includes the specific merchant industry.

20. The system of claim 11, wherein identifying the specific merchant industry includes identifying an entry associated with the merchant identifier in a lookup table that includes the specific merchant industry.
